(19) United States
(12) Patent Application Publication
(10) Pub. No.: US 2003/0013433 A1
(43) Pub. Date: Jan. 16, 2003

(54) Recommender system with user-selectable input limiting factors and output ripeness indicator

(75) Inventors: Yasser alSafadi, Yorktown Heights, NY (US); Amr F. Yassin, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/902,407

(22) Filed: Jul. 10, 2001

(51) Int. Cl. H04M 3/42

(52) U.S. Cl. 455/414; 455/66; 455/556

(57) ABSTRACT

A recommender system is disclosed for generating a recommendation in a processing device such as a portable computer, personal digital assistant (PDA) or wireless telephone. The recommender system receives an input representative of an offer or other opportunity and one or more user-specified limiting factors. The recommender system generates the recommendation based at least in part on the input and a stored profile associated with the processing device. A characteristic of the manner in which the recommendation is generated is determined in accordance with the one or more limiting factors. The recommender system also preferably generates a ripeness indicator associated with the recommendation, the ripeness indicator being indicative of the manner in which the recommendation was generated.

### FIELD OF THE INVENTION

The present invention relates generally to processing devices, such as portable computers, personal digital assistants (PDAs) and wireless telephones, that may be used to process information delivered over the Internet or other wired or wireless network, and more particularly to systems that generate recommendations for users of such devices.

### BACKGROUND OF THE INVENTION

Data processing devices such as portable computers, personal digital assistants (PDAs), wireless telephones, etc. are often configured to provide access to information available over the Internet or other wired or wireless networks. For example, access to information may be provided in these devices through wired connections, wireless connections or combinations thereof, using well-known conventional communication protocols such as the Internet Protocol (IP).

It is well known that the above-noted processing devices can be configured to include so-called recommender systems. A typical conventional recommender system processes information regarding opportunities available to a particular user, in accordance with a stored user profile, such that the user is presented only with those opportunities likely to be of greatest interest to him or her. The user profile, which includes the preferences of the corresponding user, may be stored on a mobile processing device carried by that user.

FIG. 1 is a graph illustrating the operation of a typical conventional recommender system. Such a system when making a recommendation generally goes through several iterations, which may involve gathering information from multiple sources, in order to make the recommendation. The quality of the recommendation is a function of the number of iterations, as shown in FIG. 1. As the number of iterations increases, the recommendation approaches an optimal solution indicated generally by the dashed horizontal line in the figure.

In accordance with current practice, recommender systems are routinely configured to go through a relatively large number of iterations in an attempt to reach the above-noted optimal solution. Unfortunately, this may create serious problems, particularly for mobile devices, in that the recommender system can consume excessive battery power and computing resources in its attempt to reach the optimal solution.

By way of example, a user may be carrying a mobile device that stores his or her profile and is configured for communication with a network via Bluetooth, cellular, etc. The mobile device periodically receives via the network solicitations or other types of offers from vendors or other sources of goods or services. A recommender system implemented within the device receives the offers, and utilizing the stored profile and additional information gathered from multiple sources, presents one or more of the offers to the user along with an associated recommendation as to whether or not the user should accept a particular offer.

The above-noted offer may be an offer to dine at a particular type of restaurant, and may be received by the mobile device as the user is driving past that restaurant. In this type of scenario, the recommender system must generate its recommendation very quickly, since undue delay may render the recommendation useless. It is also possible that the mobile device may receive a very large number of offers, e.g., as the user drives along a busy business corridor or walks through a shopping mall. The recommender system in attempting to process all of the offers may consume all of the available battery power. In addition, there are many situations in which the user will be satisfied with less than the optimal recommendation regarding a given offer or set of offers. Conventional recommender systems, however, generally do not have sufficient flexibility to accommodate these and other situations in an efficient manner.

A need therefore exists in the art for an improved recommender system which overcomes one or more of the above-noted problems associated with conventional recommender systems.

### SUMMARY OF THE INVENTION

The invention provides improved techniques for generating recommendations for users of portable computers, personal digital assistants (PDAs), wireless telephones or other data processing devices.

In accordance with one aspect of the invention, a recommender system receives an input representative of an offer or other opportunity, and one or more user-specified limiting factors. The recommender system generates the recommendation based at least in part on the input and a stored profile associated with the processing device. A characteristic of the manner in which the recommendation is generated is determined in accordance with the one or more limiting factors. For example, the limiting factors may specify a limit on an amount of time that may be spent by the recommender system in generating the recommendation, a limit on an amount of power consumption utilized in conjunction with generating the recommendation, or a limit on a quality measure associated with the recommendation. A given limiting factor may be selectable by the user as one of a plurality of points along a visual display scale from a low level of the limiting factor to a high level of the limiting factor.

In accordance with another aspect of the invention, the recommender system also preferably generates a ripeness indicator associated with the recommendation, the ripeness indicator being indicative of the manner in which the recommendation was generated, based on the above-noted limiting factors.

These and other features and advantages of the present invention will become more apparent from the accompanying drawings and the following detailed description.

### BRIEF DESCRIPTION OF THE DRAWINGS

FIG. 1 is a graph illustrating the operation of a conventional recommender system.

FIG. 2 is a block diagram of an example information processing system in which the present invention is implemented.

FIG. 3 shows a recommender system portion of the FIG. 2 system configured in accordance with an illustrative embodiment of the invention.

FIGS. 4, 5 and 6 illustrate example user-selectable limiting factor displays that may be utilized in conjunction with the recommender system of FIG. 3.

FIG. 7 illustrates an example ripeness indicator display that may be generated utilizing a ripeness indicator output of the recommender system of FIG. 3.

FIG. 8 shows an example of a processing device configured to implement at least a portion of the recommender system of FIG. 3.

### DETAILED DESCRIPTION OF THE INVENTION

The present invention will be illustrated herein in conjunction with an exemplary information processing system which includes a mobile processing device. It should be understood, however, that the particular system and device configurations described herein are by way of example only. The invention may be implemented using any system and device configuration that can benefit from a recommender system providing functionalities of the type described herein.

FIG. 2 shows an information processing system 200 that includes in this illustrative embodiment a mobile processing device 202, a network 204, and a set of information sources 206 including sources 206-1, 206-2, . . . 206-N. The mobile device 202 is configured for communication over the network 204 with the information sources 206. This communication may utilize well-known standard protocols, such as Bluetooth, cellular, satellite, Internet or other protocols, as well as combinations of these protocols.

The network 204 may thus represent a wireless network that connects mobile device 202 to the Internet, a fixed wireless network, a satellite network or any other type of communication medium suitable for use in coupling the mobile device 202 to the information sources 206.

One or more of the information sources 206 may represent a server or other computer accessible over the Internet, a fixed wireless transmitter, another mobile processing device, etc. These sources provide information such as solicitations and other types of offers to the mobile device 202. These sources can also provide additional information in response to queries from a recommender system.

As noted previously, the present invention does not require any particular arrangement of system processing, transmission or source elements, and elements 202, 204 and 206 are shown by way of example only. In this regard, it should be emphasized that although device 202 is illustrated as a mobile processing device in FIG. 2, the invention can be readily implemented in a non-mobile device such as a desktop personal computer or a television set-top box.

The processing device 202 in the illustrative embodiment includes a display 210 and an audio output device shown as a speaker 212.

In accordance with one aspect of the present invention, the processing device 202 is configured to include a recommender system that operates in accordance with one or more user-selectable limiting factors. The user-selectable limiting factors control at least in part the manner in which recommendations are generated by the recommender system for the corresponding user.

FIG. 3 shows a recommender system 300 that may be implemented at least in part in the processing device 202 in accordance with the present invention. The recommender system 300 receives input 302 which may comprise, e.g., information characterizing one or more offers received in the processing device 202 via the network 204. The recommender system 300 further receives one or more limiting factors 304. As will be described in detail below, the limiting factors 304 are user-specified and provide a mechanism whereby the user associated with device 202 can control the manner in which the recommender system 300 generates recommendations based on the input 302. In other words, the limiting factors 304 represent user-specified limits on various characteristics of the recommendation-generating process implemented in the recommender system 300.

The recommender system 300 processes the input 302 in accordance with the specified limiting factors 304 to generate a recommendation 306. Unlike a conventional recommendation, the recommendation 306 is generated in a manner consistent with the user-specified limiting factors 304. As a result, the recommender system 300 avoids the previously-described problems associated with conventional recommendation systems.

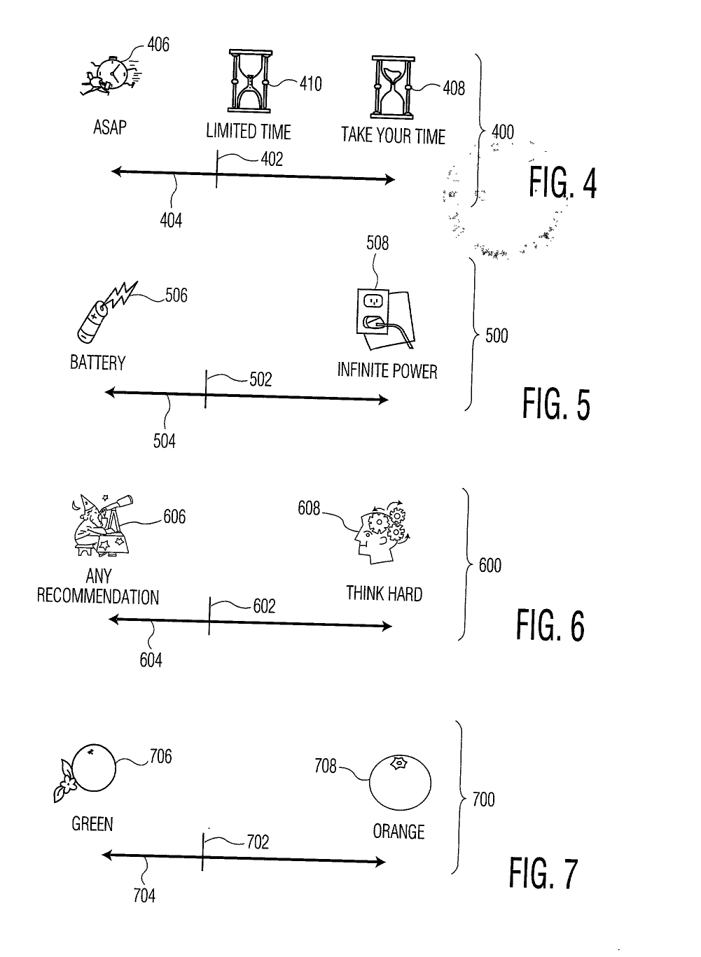

The limiting factors 304 may specify, e.g., the amount of time a recommender system should spend in generating the recommendation, the amount of power or other device resources that may be consumed by the recommendation system 300 in generating the recommendation, the quality of the recommendation needed in a particular application, or combinations of these and other limiting factors. Example limiting factors and the manner in which these factors may be selected by a user of the device 202 will be described in conjunction with FIGS. 4, 5 and 6.

FIG. 4 illustrates a user-selectable limiting factor display 400 configured to allow a user to select an amount of time that may be spent by recommender system 300 in generating a recommendation. The display 400, and other displays to be described below in conjunction with FIGS. 5, 6 and 7, are assumed to be viewable to the user as at least a portion of the display 210 of device 202. The amount of time that may be spent is selectable by the user as one of a plurality of points, e.g., a given selected point 402, along a scale 404 from a first icon 406 representative of a low level of the limiting factor to a second icon 408 representative of a high level of the limiting factor. The selected point 402 in this example has an icon 410 associated therewith.

The scale 404 goes from the icon 406 indicating that the recommendation should be generated as soon as possible (ASAP), to the icon 408 indicating that the recommender system 300 should “take its time” in generating the recommendation, e.g., take an amount of time needed to generate an optimal or near-optimal solution. The selected point 402 corresponds to a particular limited amount of time, and its icon 410 is indicative of the particular limited amount of time.

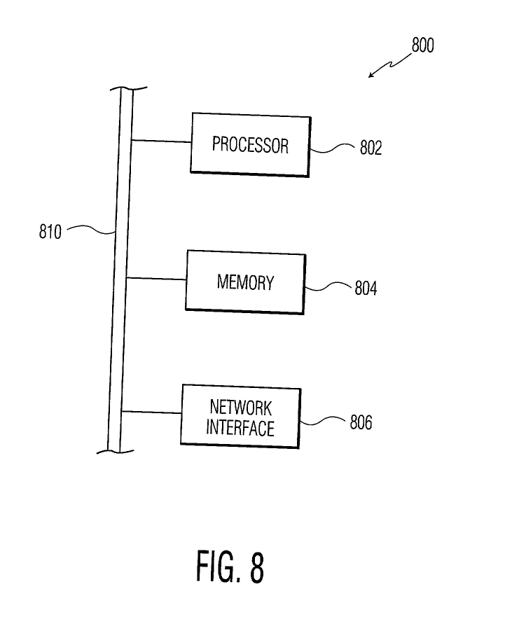

The display 400 and other selectable limiting factor displays to be described in conjunction with FIGS. 5 and 6 below may be configured such that a given point along the scale is selectable by user entry of appropriate commands, e.g., via a mouse, stylus or other point, click and drag mechanism, via keyboard, via speech recognition software, etc. For example, a user may click and drag a selected point indicator to a particular selected point, such as point 402 as shown in FIG. 4. This information is fed back from the display to an appropriate processor used to implement the recommender system 300, as will be described below in conjunction with FIG. 8.

FIG. 5 illustrates a user-selectable limiting factor display 500 configured to allow a user to specify a limit on an amount of power consumption that may be utilized in conjunction with generating a recommendation. Again, as noted above, the display 500 and other displays to be described herein are assumed to be viewable to the user as at least a portion of the display 210 of device 202. The amount of power consumption that may be utilized is selectable by the user as one of a plurality of points, e.g., a given selected point 502, along a scale 504 from a first icon 506 representative of a low level of the limiting factor to a second icon 508 representative of a high level of the limiting factor. The scale 504 goes from the icon 506 indicating that the recommendation should be generated in a manner appropriate for the limited power consumption of a battery-based device, to the icon 508 indicating that the recommender system 300 has “infinite power” for use in generating the recommendation, e.g., the device is plugged into a wall electrical socket as shown in the icon 508. The selected point 502 corresponds to a particular amount of authorized power consumption for use in generating one or more recommendations.

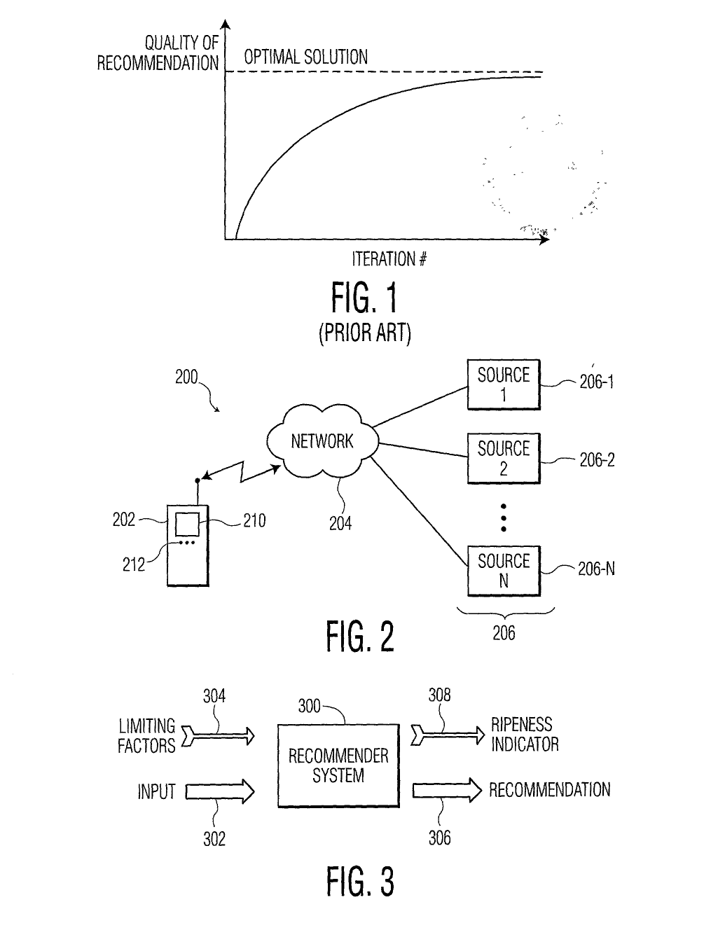

FIG. 6 illustrates a user-selectable limiting factor display 600 configured to allow a user to specify a limit on a quality measure associated with generation of a recommendation. The quality measure in this example is selectable by the user as one of a plurality of points, e.g., a given selected point 602, along a scale 604 from a first icon 606 representative of a low quality recommendation to a second icon 608 representative of a high quality recommendation. The scale 604 goes from the icon 606 indicating that a rapidly-generated recommendation, e.g., “any recommendation,” is preferred, to the icon 608 indicating that the recommender system 300 should “think hard” in generating the recommendation, e.g., execute more iterations so as to more closely an optimal solution as indicated in FIG. 1. The selected point 602 corresponds to a particular limit on a quality measure for use in generating one or more recommendations.

Limiting factors selected by a given user can be stored as part of a corresponding user profile for utilization in generating particular types of recommendations. For example, a user may prefer relatively quick recommendations when it comes to offers involving particular types of goods or services or offers received in particular situations, but may prefer that the system generate a higher quality recommendation for offers involving other types of goods and services or offers received in other situations. Once a user has selected a given type of limiting factor for use with a particular offer or situation, that selected factor may be stored as part of the user profile.

It should also be noted that the recommender system 300 may be configured to convert certain limiting factors into other limiting factors. For example, factors such as power consumption and quality as described in conjunction with FIGS. 5 and 6, respectively, may be converted by the recommender system 300 to a time-based limiting factor such as that described in conjunction with FIG. 4.

FIG. 7 shows an example of a ripeness indicator display 700 that may be generated using the ripeness indicator 308 output of the recommender system 300. In this example, the ripeness indicator 308 is represented by a particular point 702 along a scale 704 from a first level of ripeness represented by an icon 706 to a second level of ripeness represented by an icon 708. The ripeness indicator 308 may thus vary in this example from the first icon 706 in the form of an unripe or “green” orange to the second icon 708 in the form of a ripe or “orange” orange.

This example thus utilizes a fruit metaphor to facilitate understanding of a particular output recommendation. More particularly, people sometimes buy green oranges, bring them home and wait for a number of days until the oranges become ripe. They observe as the fruit changes color, how ripe it is for consumption. A user receiving a recommendation generating in accordance with one or more of the above-described limiting factors would generally like to know how “ripe” the recommendation is, and the display 700 provides this function.

More generally, the ripeness indicator when implemented in a visual display may comprise at least a first state corresponding to a first color and a second state corresponding to a second color. In the FIG. 7 example, the first state is represented by the “green” orange icon 706 and the second state is represented by the “orange” orange icon 708, with the particular value of the ripeness indicator for a given recommendation being represented by the point 702 along the scale 704.

FIG. 8 shows an example of a processing device 800 that may be used to implement at least a portion of the recommender system 300 of FIG. 3. It should be noted that the recommender system 300 may be implemented in a distributed manner, e.g., across the processing device 202 and at least one additional device external to the processing device 202, or across multiple devices external to the processing device 202. The recommender system 300 may alternatively be implemented substantially in its entirety within the processing device 202. The processing device 800 of FIG. 8 may thus be viewed as one possible implementation of the recommender system 300 or a suitable portion thereof.

The device 800 includes a processor 802, a memory 804 and a network interface 806 which communicate over at least a portion of a set 810 of one or more system buses. The device 802 may represent a desktop or portable computer, a PDA, a wireless telephone, a smart remote control, a television, a set top box, or any other type of processing device for which it is desirable to provide access to the functionalities of the recommender system 300. The elements of the device 800 may be conventional elements of such devices.

For example, the processor 802 may represent a microprocessor, central processing unit (CPU), digital signal processor (DSP), or application-specific integrated circuit (ASIC), as well as portions or combinations of these and other processing devices. The memory 804 is typically an electronic memory, but may comprise other types of storage devices, such as disk-based optical or magnetic memory. The network interface 806 is configured to allow communication between the device 802 and a network such as network 204 of FIG. 2.

The recommender techniques described herein may be implemented in whole or in part using software stored and executed using the respective memory and processor elements of the device 800. For example, one or more of the above-described functions of the recommender system 300 may be implemented at least in part using one or more software programs stored in memory 804 and executed by processor 802. The particular manner in which such software programs may be stored and executed in device elements such as memory 804 and processor 802 is well understood in the art and therefore not described in detail herein.

It should be noted that the device 800 may include other elements not shown, or other types and arrangements of elements capable of providing the content conditioning functions described herein. For example, the device 800 may include a display suitable for presenting icons such as those shown in FIGS. 4 through 7 to the user.

The above-described embodiments of the invention are intended to be illustrative only. For example, the invention can be used in other types of information processing systems and devices using other arrangements of processing elements. In addition, as indicated above, the particular limiting factors used may vary depending upon the device and the processing application. Moreover, although illustrated using visually-perceptible presentations of limiting factors and ripeness indicators, the invention may also or alternatively make use of audibly-perceptible presentations of such elements, e.g., generated using speaker 212 of device 202. These and numerous other embodiments within the scope of the following claims will be apparent to those skilled in the art.

What is claimed is:

1. A method for use in an information processing system for generating a recommendation at a processing device, the method comprising the steps of:
receiving an input and one or more limiting factors in a recommender system, at least a subset of the one or more limiting factors being selectable by a user of the device; and
generating an output recommendation based at least in part on the input and a stored profile associated with the device, a characteristic of the generating step being configured by the recommender system in accordance with the one or more limiting factors.

2. The method of claim 1 further including the step of generating a ripeness indicator associated with the output recommendation, the ripeness indicator being indicative of the characteristic of the generating step as configured in accordance with the one or more limiting factors.

3. The method of claim 2 wherein the ripeness indicator comprises a visual indicator having at least a first state corresponding to a first color and a second state corresponding to a second color.

4. The method of claim 2 wherein the ripeness indicator comprises an audible indicator.

5. The method of claim 1 wherein at least a subset of the one or more limiting factors are selectable via a user interface of the processing device.

6. The method of claim 1 wherein the limiting factor comprises a specified limit on an amount of time that may be spent by the recommender system in generating the output recommendation.

7. The method of claim 1 wherein the limiting factor comprises a specified limit on an amount of power consumption utilized in conjunction with generating the output recommendation.

8. The method of claim 1 wherein the limiting factor comprises a specified limit on a quality measure associated with the output recommendation.

9. The method of claim 1 wherein a given limiting factor is selectable by the user as one of a plurality of points along a scale from a low level of the limiting factor to a high level of the limiting factor.

10. The method of claim 1 wherein the processing device is configured for presentation of the output recommendation in a visually-perceptible manner on a display of the device.

11. The method of claim 1 wherein the processing device is configured for presentation of the output recommendation in an audibly-perceptible manner using a speaker associated with the device.

12. The method of claim 1 wherein the processing device comprises at least one of a desktop or portable personal computer, a personal digital assistant, a wireless telephone and a set top box.

13. The method of claim 1 wherein the one or more limiting factors are stored as part of the profile.

14. An apparatus for use in generating a recommendation in a processing device of an information processing system, the apparatus comprising:
a memory for storing a profile associated with the device; and
a processor coupled to the memory, the processor being operative to process an input and one or more limiting factors in an implementation of a recommender system, at least a subset of the one or more limiting factors being selectable by a user of the device, and to generate an output recommendation based at least in part on the input and the stored profile associated with the device, a characteristic of the recommendation generation operation being configured by the recommender system in accordance with the one or more limiting factors.

15. An article of manufacture comprising a machine-readable storage medium containing one or more software programs for use in generating a recommendation in a processing device of an information processing system, wherein the one or more software programs when executed implement the steps of:
receiving an input and one or more limiting factors in a recommender system, at least a subset of the one or more limiting factors being selectable by a user of the device; and
generating an output recommendation based at least in part on the input and a stored profile associated with the device, a characteristic of the generating step being configured by the recommender system in accordance with the one or more limiting factors.
